(19) United States
(12) Patent Application Publication
(10) Pub. No.: US 2008/0228545 A1
(43) Pub. Date: Sep. 18, 2008

(54) Live multimedia product catalog system that integrates with on-line stores

(76) Inventor: Jianfeng Jiang, San Jose, CA (US)

Correspondence Address: Jianfeng Jiang, 1175 Valley Quail Circle, San Jose, CA, 95120, US

(21) Appl. No.: 11/983,191

(22) Filed: Nov. 8, 2007

Related U.S. Application Data
(63) Continuation-in-part of application No. 11/717,850, filed on Mar. 15, 2007.

(51) Int. Cl. G06Q 30/00; G06F 17/30; G06Q 10/00

(52) U.S. Cl. 705/8; 705/14; 705/40

(57) ABSTRACT

A live multimedia product catalog system that integrates with online stores includes at least one on-line provider of advertisements or online goods, a module to make and edit catalogs, a module to publish advertisements or online goods to each catalog, a network management module and desktop application programs to retrieve the multimedia catalogs automatically and display the contents. The live catalogs can be put on websites, or download to desktops, or put on portable storage medium. These catalogs only needs to be downloaded once, their contents are automatically updated.

### FIELD OF INVENTION

This invention relates to on-line shopping, on-line gaming, on line entertainment, on line advertisements, out-of-home advertisements, electronic magazines, direct mails (DM), product catalogs and e-commerce.

### BACKGROUND OF THE INVENTION

Businesses are printing many catalogs and distributing to their customers. The printing & mailing cost are very high. Also, these printed catalogs are not timely responsive, the customers cannot get real time product info through the printed catalogs. Furthermore, these printed catalogs cannot convey video or sound which are very useful to help customers making buying decisions. Lastly, these printed catalogs are not directly linked to businesses' online stores. If the customer is interested in buying a product, they have to fill out a paper order form or telephone to place the order, or go to businesses' website and search for the product.

In other Business-to-business situations like exhibitions where professional buyers and manufactures are gathering to make trades. Traditionally, the host company makes printed catalog with all the participating manufactures paying to list their products in the catalog, and the professional buyers get a free copy of the catalog or pay a small fee for it. These catalogs have the same above mentioned shortcomings. On the other hand, many businesses are making online catalogs and put them on the website for customers to download. Most of the online catalogs are simply adobe .pdf files, customers have to download them every time, download speed is slow and in reality only a very small percentage of customers download them.

Furthermore, many businesses are putting their product catalogs on CDs or DVDs and send to their customers, but like the printed catalogs, they are not live, the information in the CDs or DVDs are fixed and cannot be updated automatically.

Lastly, when a person wants to send pictures or video to a friend, presently he can only send them through E-mail, his friend will open the e-mail and then save to their desktops one by one, and the process is quite inconvenient.

### SUMMARY OF THE INVENTION

In accordance with one aspect of the invention, the live multimedia product catalog system that integrates with on-line stores consists of at least one online provider of advertisements or on-line goods, a module to make and edit different catalogs, a module to publish on-line advertisements or on-line goods to selected catalogs, a network management module and desktop application programs to retrieve multimedia catalogs automatically and display the contents.

In accordance with another aspect of the invention, the live multimedia product catalog that integrates with on-line stores allows businesses to easily make multimedia catalogs, set their attributes and put them on websites, viewers can view them online or download to their desktops.

In accordance with one other aspect of the invention, the multimedia product catalogs are live, viewers only need to download them once. The contents will be automatically retrieved from a remote server in real time, and viewers just need to click on the desktop E-catalog and receive the real-time multimedia information from the businesses.

In accordance with one other aspect of the invention, each catalog can have one small index file which can be downloaded first before downloading the bulk contents. The index file may contain a cover page, category buttons, remote server information for downloading, total number of contents and the content identification numbers.

In accordance with one other aspect of the invention, when there are updates or new contents in any of the downloaded catalogs, special symbol will appear on the desktop program shortcut icon and the cover of each catalog that has updates or new contents.

In accordance with one other aspect of the invention, the live multimedia product catalog that integrates with on-line stores allows businesses to easily define their product category tree for each live catalog. If businesses do not define their own category, then the default category tree will be used.

In accordance with one other aspect of the invention, the live multimedia product catalog that integrates with on-line stores allows businesses to easily register new ads or products, and select any live catalogs, set the play mode: to be played automatically or to be listed only under the category buttons, and set the time and date for each ads or product to be published in the selected catalogs.

In accordance with one other aspect of the invention, each catalog can have a partner list so that businesses in the partner list can select this catalog according to the catalog's attributes and publish their ads or product info to this catalog.

In accordance with one other aspect of the invention, the contents send by businesses in the partner list may subject to review of the catalog owner. The catalog owner may delete the contents at his discretion.

In accordance with one other aspect of the invention, there is an automatic billing system: the owner of the catalog can set the pricing for each ad or product listings, the other businesses that send their ads or products into this catalog will automatically get an estimation of the cost so that they can make changes according to their budgets. Once the ads or products are submitted, the actual cost will be recorded and send to the businesses automatically.

In accordance with one other aspect of the invention, the ads or products in each catalog can be played in the automatic mode, or be listed under each category, or be found through key word search box.

In accordance with one other aspect of the invention, each ad or product in the desktop E-catalogs are directly linked with on-line stores. Each ad or product can be checked out from different sources of on-line stores. If a viewer is interested in one product, click on a “buy” button, he can check out from the designated on-line store.

In accordance with one other aspect of the invention, each ad or product in the desktop E-catalogs are in the web-content format, like dhtml.

In accordance with one other aspect of the invention, the live e-catalogs can be put on portable storage medium, such as CD, DVD, flash memory cards, portable hard-disk etc. The desktop application programs and the installation programs may also be included in the portable storage medium. Users can directly download the live catalogs onto their PCs using these portable mediums.

In accordance with one other aspect of the invention, the live e-catalogs can be used as live communication channels between businesses and their customers. Each live e-catalog is equivalent to a cable TV channel except using internet and also integrated with online stores. Viewers only need to click on the desktop live catalogs to receive the multimedia information send by the businesses.

In accordance with one other aspect of the invention, many businesses' live e-catalogs can be put in one portable storage medium, like DVD, CD etc. This portable medium is equivalent to having many businesses' website in one portable medium.

In accordance with one other aspect of the invention, the live e-catalogs can be used as a convenient tool for person to exchange pictures or videos, in this case, we may call the live e-catalogs as live albums. A person can set up different live albums for his friends or family. His friends or family only need to download the album once onto their desktop. Later on, his friends or family can just click on the desktop album to receive the latest photos or videos send by him, without going through the trouble of opening e-mails and save each picture one by one.

### BRIEF DESCRIPTION OF THE DRAWINGS

FIG. 1 is a schematic representation of the live multimedia catalog system that integrates with online stores in accordance with the invention.

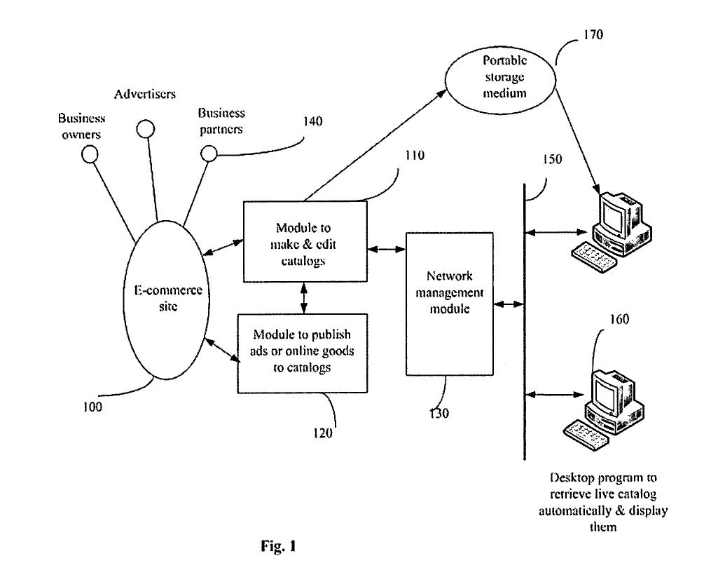

### DETAILED DESCRIPTION OF THE INVENTION

The present invention relates to a new live multimedia product catalog system that integrates with online stores. The following description is presented to enable one of ordinary skill in the art to make and use the invention as provided in the context of a particular application and its requirements. Various modifications to the preferred embodiment will be apparent to those with skill in the art and the general principles defined herein may be applied to other embodiments. Therefore, the present invention is not intended to be limited to the particular embodiments shown and described, but is to be accorded the widest scope consistent with the principles and novel features herein disclosed.

The live multimedia product catalog system that integrates with online stores may include at least one online provider of advertisements or online goods 100, a module 110 to make and edit catalogs, a module 120 to publish ads or online goods to catalogs, portable storage medium 170, a network management module 130, and desktop application programs 160 to read and retrieve live catalogs.

The at least one online provider of advertisements 100 has secured log-ins for users 140. The users can easily define different kinds of live catalogs according to their customers' classifications. Set attributes to each catalog such as catalog category, targeted area, targeted population etc. Select different templates for each catalog, upload the cover page, background music etc.

Users can define their own product category tree, or use the default category tree.

Users can register their products or ads according to their own product category tree, or use the default category tree. Each product registration can include all the elements of online store product listings, such as title, price, return policy, detailed description, photos and videos. For the said invention, each product registration also include the designated online store for checking out, otherwise, the default online store will be used for checking out.

Once products or ads are registered, user can select any of his live catalogs, set the play mode: to be played automatically or to be listed under the category buttons, and set the date and time the product or ad will be published in the catalogs.

When viewers open the live catalog, he may view the contents in automatically play mode, or look them up under the category buttons or do a key word search using the search box.

The catalog owner can set up a partner list for each of his live catalogs, so that the partners in the list will be able to select this catalog according to its attributes, send their products or ads directly into the said owner's catalogs. The said owner has the authority to review and delete the listings from his partners.

There is also an automatic billing system: the owner of the catalog can set the pricing of each ad or product listings. Businesses that send ads to this catalog will automatically get an estimate of the cost, and the businesses can then make changes according to their budget. Once ads are submitted, actual bills will be automatically generated and send to the businesses.

The live catalogs can be put on any websites for viewers to view online, or download them to their desktops. To view these catalogs on desktop, the viewers need to download a desktop application program which we may call live catalog reader. The user can also put the live catalogs on portable storage medium 170, such as CD, DVD, flash memory cards, portable hard-disk etc. The desktop application programs and the installation programs may also be included in the portable storage medium. Users can directly download the live catalogs onto their PCs using these portable storage mediums.

For easy of use, the desktop program can be represented by a shortcut icon on the desktop, viewers only need to click on the icon to open the catalog reader. When there are updates or new contents in any of the downloaded catalogs, special symbol will appear on the desktop shortcut icon and the cover of each catalog that has updates or new contents. The said catalog is live in the sense that it only needs to be downloaded once. Once it's downloaded to the desktop of a computer connected to the internet, the content updating module of the desktop application program will periodically check the remote server for any updates or revisions of any contents in any catalogs downloaded. If any updates or revisions detected, it will automatically retrieve the updated contents. So the viewers just need to click on the desktop catalog to view the latest multimedia ads or product info sent by the businesses. All ads or products are in rich content format, and viewers can see all the detailed product info as listed on line. If the viewer is interested in buying the product, just click on the “buy” button, he will be directed to the designated online store to check out the product.

To speed up the downloading process, each live catalog may include a small index file which may contain a cover page, category buttons, remote server information for downloading, total number of contents and the content identification numbers. When viewers download a live catalog, the index file will be downloaded first. After index file is downloaded, the content updating program will automatically start, which periodically check the remote server for any updates of any of the downloaded live catalogs and automatically retrieve the updated contents.

Whenever there are any new contents in any of the downloaded catalogs, the desktop shortcut icon will change to a different icon. After the viewer read the new contents, the desktop icon will go back to the normal one. Once the viewers open the catalog reader, there is a special symbol on the cover of those catalogs with new un-read contents. The special symbol will disappear once the viewer read the new contents.

1. A live multimedia product catalog system that integrates with on line stores comprising:
At least one on-line provider of advertisements or on-line goods
A module to make and edit different catalogs
A module to publish on-line advertisements or on-line goods to selected catalogs
A network management module
Portable storage medium
And desktop application programs to retrieve multimedia catalogs automatically and display the contents.

2. The live multimedia product catalog system of claim 1, wherein businesses can easily make different multimedia catalogs, set each catalog's attributes, put them on websites. Viewers can view these catalogs online or download them to the desktops.

3. The live multimedia product catalog system of claim 2, wherein each catalog's attribute may contain indication whether the catalog is open to all viewers, or only open to a special group of people so that it requires a password to download or to open the catalog.

4. The live multimedia product catalog system of claim 2, wherein each catalog's attribute may contain description of each catalog, its targeted location, the profiles of the targeted viewers etc.

5. The live multimedia product catalog system of claim 1, wherein the multimedia product catalogs downloaded to the desktop are live, viewers only need to download them once. The desktop application program periodically check the remote server hosting the catalogs for any updates or new contents in each of the downloaded catalogs, and automatically download the updates or new contents. Viewers only need to open the desktop catalogs to receive the latest multimedia information from businesses.

6. The live multimedia product catalog system of claim 1, wherein each catalog can have one small index file which can be downloaded first before downloading the bulk contents. The index file may contain a cover page, category buttons, remote hosting server information for downloading, total number of contents and each content's identification number etc.

7. The live multimedia product catalog system of claim 1, wherein the desktop application program can be placed on the desktop using a shortcut icon. And special symbols are placed on the shortcut icon and on the cover page of each catalog to indicate that there are updates or new contents in any of the catalogs downloaded.

8. The live multimedia product catalog system of claim 1, wherein businesses can easily define the product category tree for each catalog. Otherwise, the default category will be used.

9. The live multimedia product catalog system of claim 1, wherein businesses can easily register new ads or products, and select any catalogs according to their attributes, set the time and date for each ad or product to be published in the catalog.

10. The live multimedia product catalog system of claim 1, wherein the owner of each catalog can set a partner list for the catalog, so that businesses in the partner list can select this catalog and publish their ads or products to this catalog.

11. The live multimedia product catalog system of claim 10, wherein the owner of each catalog has the right to review and delete ads or products send by businesses in the partner list.

12. The live multimedia product catalog system of claim 10, wherein there is an automatic billing system: the owner of the catalog can set the pricing for each ad or product listings, the other businesses that send their ads or products into this catalog will automatically get an estimation of the cost so that they can make changes according to their budgets. Once the ads or products are submitted, the actual cost will be recorded and send to the businesses.

13. The live multimedia product catalog system of claim 1, wherein the ads or products in each catalog can be played in the automatic mode, or be listed under each category, or be found through key word search box.

14. The live multimedia product catalog system of claim 1, wherein each ad or product in the catalog can have a different designated link to an online store for checking out. If no designated online store link is provided, the default online store will be used. Once a viewer is interested in buying the product, click on the “buy” button of the catalog, he will be directed to the designated online store to check out.

15. The live multimedia product catalog system of claim 1, wherein each ads or products in the catalogs are in the web-content format, like dhtml.

16. The live multimedia product catalog system of claim 1, wherein the catalogs can be put on portable storage medium, such as CD, DVD, flash memory cards, portable hard-disks etc. The desktop application programs and the installation programs may also be included in the portable storage medium. Users can directly download the live catalogs into their PCs using these portable storage medium.

17. The live multimedia product catalog system of claim 1, wherein each catalog is a desktop live communication channel between businesses and their customers, combined with online store.

18. The live multimedia product catalog system of claim 1, wherein many businesses' live catalogs can be put on portable storage medium, such as CD, DVD, magnetic storage devices, flash memory cards etc. These portable medium is equivalent to containing many businesses' websites.

19. The live multimedia product catalog system of claim 1, wherein each live catalog can be used for friends and family members to exchange pictures and videos without going through the traditional process of sending through E-mail and then download them to their desktops. The pictures or videos are automatically downloaded to the desktops.
